(19) United States
(12) Patent Application Publication
(10) Pub. No.: US 2018/0202471 A1
(43) Pub. Date: Jul. 19, 2018

(54) PRESSURE OPERATING DEVICE

(71) Applicant: Eric TSOU, Taipei City (TW)

(72) Inventor: Eric TSOU, Taipei City (TW)

(21) Appl. No.: 15/804,629

(22) Filed: Nov. 6, 2017

(30) Foreign Application Priority Data
Jan. 19, 2017 (TW) 106101847

(51) Int. Cl. F15B 13/06; F16K 11/14; F15B 11/16

(52) U.S. Cl. CPC F15B 13/06; F15B 2211/523; F15B 11/16; F16K 11/14

(57) ABSTRACT

A pressure operating device includes several valves disposed at fluid channels of a base such that high pressure fluid compels the valves to a closed position; a pressure disk disposed above the base and several swing arms extending from a swing seat; a guide member having an axial hole and several guide channels surrounding the axial hole, and an operating rod unit extending through the axial hole for coupling with the swing seat in such a manner that movement of the operating rod unit into one guide channel results in swinging of the swing seat into the guide channel, thereby swinging a respective one of the swing arms above and pressing a corresponding valve downward and opening the corresponding valve to permit entry of the high pressure fluid into the pressure operating device while remaining the swing arms are spaced apart from and maintaining remaining valves in the closed position.

### CROSS-REFERENCE TO RELATED APPLICATION

This application claims the priority of Taiwanese patent application No. 106101847, filed on Jan. 19, 2017, which is incorporated herewith by reference.

### BACKGROUND OF THE INVENTION

### 1. Field of the Invention

The present invention relates generally to a pressure operating device, and more particularly to a pressure operating device for use in a hydraulic power machine.

### 2. The Prior Arts

Heavy machines are prevalent nowadays and traditional heavy machines especially those seen in construction sites, like dump trucks or derrick cranes, require relatively high output power, such as hydraulic power. Therefore, these machines are equipped with motors operated by high compressed fluid to provide high-pressure hydraulic power. An internal combustion engine is generally employed in an engineering machine. In order to activate the engineering machine, a high-compressed fluid is introduced into the internal combustion engine or the high-compressed fluid operated pump and after finishing the designate task of the engineering machine, introduction of high-compressed fluid is stopped, such as via clutch mechanisms, to prevent damage caused to any one of the devices.

During designing a conventional engineering machine, an operating device is utilized in order to operate a hydraulic power machine. The operating device is categorized into two types; namely electrical power and pneumatic power. To be more specific, since compressed-pressure devices are employed in an engineering machine, the pneumatic power is more suitable to drive a hydraulic power machine.

A conventional pressure operating device includes a base seat formed with a plurality of fluid channels, a plurality of piston valves disposed respectively at the fluid channels such that the piston valves are located at a closed position due to high compressed fluid, a pressure disk disposed on the base seat so as to be located on the piston valves and an operating rod unit coupled with the pressure disk such that in case the operator swings the operating rod unit towards any one the piston valves so as to move a respective one of the piston valves downward, thereby opening the respective one of the piston valves and allowing the high-compressed fluid to enter into the pressure operating device and hence activating the hydraulic power machine.

It is noted that the pressure disk is circular such that sidewise swinging of the pressure disk can result in compression of the piston valves, thereby opening more than two of the piston valves and allowing the high-compressed fluid to enter into the pressure operating device and hence activating the hydraulic power machine in multiple operating modes. Thus, undesired accidents can cause to any environment around the hydraulic power machine.

In addition, since the operating rod unit can swing freely relative the base seat, in case the operator is resting and if the operating rod unit is accidentally activated so as to open any one of the piston valves, the high-compressed fluid may enter into the pressure operating device and hence drives the hydraulic power machine, which, in turn, may cause hazardous events.

### SUMMARY OF THE INVENTION

A primary objective of the present invention is to provide a pressure operating device, which can precisely control and activate only a single one from a plurality of piston valves such that the pressure operating device can activate a hydraulic power machine in a single operating mode only, thereby preventing activation of the hydraulic power machine in multiple operating modes and enhancing the precise operation of the hydraulic power machine.

Another objective of the present invention to provide a pressure operating device, in which when the operating rod unit is not in the operation position, it can not swing with respect to a base seat so as to prevent the operator from accidentally manipulating the operating rod unit and hence preventing the high-compressed fluid from entering into the pressure operating device and activating the hydraulic power machine.

In order to achieve the above objectives, a pressure operating device of the present invention for a hydraulic power machine includes: a base seat, a pressure disk, a guide member and an operating rod unit.

The base seat is formed with a plurality of fluid channels.

The plurality of piston valves are disposed respectively at the fluid channels such that high pressure fluid coming in from a pneumatic power source is capable of compelling and disposing the piston valves at a closed position.

The pressure disk includes a swing seat disposed above the base seat and a plurality of swing arms extending outwardly from the swing seat and disposed respectively above the piston valves.

The guide member is disposed above the pressure disk, has an axial hole and a plurality of guide channels surrounding and in spatial communication with the axial hole and corresponding to the swing arms.

The operating rod unit extends through the axial hole in the guide member for coupling with the swing seat.

Movement of the operating rod unit along one of the guide channels results in swinging of the swing seat to a respective one of the guide channels, thereby swinging a respective one of the swing arms above and pressing a corresponding one of the piston valves downward and opening the corresponding one of the piston valves to permit entry of the high pressure fluid into the pressure operating device while remaining the swing arms are spaced apart from and maintaining remaining the piston valves in the closed position.

Preferably, the pressure operating device of the present invention further includes a position restricting member coupled to the operating rod unit so as to restrict the operating rod unit between a locked position, where the position restricting member is inserted into the axial hole in the guide member to prevent movement of the operating rod unit into any one of the guide channels of the guide member and subsequently preventing swinging of the swing seat relative to the guide member and an unlocked position, where the position restricting member disengages from the axial hole in the guide member to permit movement of the operating rod unit into any one of the guide channels of the guide member and subsequently permitting swinging of the swing seat relative to the guide member.

Preferably, the operating rod unit includes a head, an operating shaft coupled to the head and extending through the axial hole in the guide member for coupling with the swing seat, and a tubular sleeve sleeved around the operating shaft and disposed adjacent to the head. The position restricting member includes an outer sleeve sleeved around the operating shaft and defining an axial hole, an inner sleeve disposed within the axial hole and sleeved around the operating shaft to expose at least partially of the inner sleeve from a bottom end of the outer sleeve and having an inner peripheral surface defining a large diameter section to permit extension of the tubular sleeve, a small diameter section and a shoulder portion between the large diameter section and the small diameter section, and a spring disposed within the inner sleeve around the operating shaft and having two opposite ends respectively biasing the shoulder portion and the tubular sleeve biasing the inner sleeve into the axial hole in the guide member subsequently preventing the operating shaft from entering into any one of the guide channels of the guide member and preventing swinging of the swing seat relative to the guide member, thereby disposing the position restricting member at the locked position, and simultaneous upward movement of the outer and inner sleeves along the operating shaft results in compression of the spring and disengaging the inner sleeve from the axial hole in the guide member to allow the operating shaft entering freely into any one of the guide channels of the guide member and subsequently permitting swinging of the swing seat relative to the guide member, thereby disposing the position restricting member is at the unlocked position.

Preferably, the outer sleeve further has an annular first flange extending outwardly and radially from a periphery confining an upper part of the outer sleeve and the inner sleeve further has an annular second flange extending outwardly and radially from a periphery confining an upper part of the inner sleeve such that the second flange is located above and detachably contact with the first flange of the outer sleeve.

Preferably, the pressure operating device of the present invention further includes a protection sheath disposed on the base seat for covering and concealing the plurality of fluid channels, the piston valves, the pressure disk, the guide member and exposing partially the inner and outer sleeves of the position restricting member, and the head and the operating shaft of the operating rod unit.

Preferably, the guide member includes a guide seat formed with the axial hole and the guide channels and a plurality of support legs disposed between the guide seat and the base seat so as to define a receiving space thereamong to accommodate the swing seat in such a manner that each of the swing arms extends from the swing seat outwardly of the receiving space.

In a more specific manner, each of the support legs extends outwardly and downwardly from the guide seat toward the base seat while each of the swing arms extends outwardly of the receiving space through an adjacent pair of the support legs, thereby disposing the support legs on an upper side of the base seat.

Preferably, the base seat further has a plurality of fixing fixtures on the upper side thereof, each is formed with an insert hole and located between an adjacent pair of the fluid channels. Each of the support legs includes an extension portion and a insert pin. Each extension portion has first and second extension plates extending downwardly and outwardly from the guide seat, a third extension plate extending downward from the guide seat for interconnecting with the first and second extension plates and a fourth extension plate extending outward from a bottom end of the third extension plate away from the guide seat for interconnecting with the first and second extension plates and formed with a through hole. Each insert pin has a pin head and a pin shaft with a cross section smaller than the pin head and extending through the through hole in the fourth extension plate and inserted into the insert hole of a respective one of the fixing fixtures, thereby disposing the pin head among the first, second, third and fourth extension plates and subsequently mounting the support legs of the guide seat securely on the base seat but not hindering swinging of the swing seat relative to the base seat.

Preferably, an upper side of the base seat is formed with a socket. The swing seat includes a swing body defining a large diameter portion for receiving the operating shaft of the operating rod unit and a small diameter portion below the large diameter portion and a universal joint having a head body for movably disposed in the socket of the base seat and a post body extending from the head body and coupling with the small diameter portion of the swing body.

Preferably, each of the swing arms includes an arm body extending outwardly and radially from a bottom portion of the swing body and formed with a through hole and a press block having a press head and a press pin being smaller than the press head in cross section and extending through the through hole in the arm body so as to dispose the press head above a corresponding one of the piston valves.

The features of the present invention resides in that the guide member is capable of assisting precise control of the operating shaft so as to swing the pressure disk toward a single piston valve only, thereby opening the single piston valve to allow entry of high-compressed fluid into the pressure operating device of the present invention, thereby activating the hydraulic power machine in a single operation mode. In other words, the hydraulic power machine provided with the pressure operating device of the present invention is prevented from being activated in multiple operation modes, thereby enhancing the precise control of the operation mode of the hydraulic power machine. In addition, when the position restricting member is disposed in the locked position, the operating shaft is prevented from entering into any one of the guide channels in the guide seat and subsequently preventing swinging of the swing seat relative to the base seat. In other words, the operating shaft is prevented from accidentally moved by an external force, thereby providing additional safety effect to the environment or the operator operating the hydraulic power machine.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a pressure operating device of the present invention;

FIG. 2 is a perspective and exploded view of the pressure operating device of the present invention;

FIG. 3 is a lateral side view of the pressure operating device of the present invention;

FIG. 4 is a cross-sectional view of the pressure operating device of the present invention;

FIG. 5A illustrates a perspective view of the pressure operating device of the present invention at an unlocked position;

FIG. 5B illustrates a perspective and lateral side view of the pressure operating device of the present invention at the unlocked position;

FIG. 5C illustrates a perspective and cross-sectional view of the pressure operating device of the present invention at the unlocked position;

FIG. 6A shows a perspective movement of an operating shaft into one of plurality of guide channels in a guide seat so as to swing a swing seat relative to a base seat to extend one swing arm of the swing seat compressing a piston valve below in the pressure operation device of the present invention;

FIG. 6B shows a lateral side movement of the operating shaft into one of plurality of guide channels in the guide seat so as to swing the swing seat relative to the base seat to extend the swing arm of the swing seat compressing the piston valve below in the pressure operation device of the present invention;

FIG. 6C shows a cross-sectional movement of the operating shaft into one of plurality of guide channels in the guide seat so as to swing the swing seat relative to the base seat to extend the swing arm of the swing seat compressing the piston valve below in the pressure operation device of the present invention; and

FIG. 7 shows a perspective view of a modified pressure operating device of the present invention.

### DETAILED DESCRIPTION OF THE PREFERRED EMBODIMENTS

The accompanying drawings are included to provide a further understanding of the invention, and are incorporated in and constitute a part of this specification. The drawings illustrate embodiments of the invention and, together with the description, serve to explain the principles of the invention.

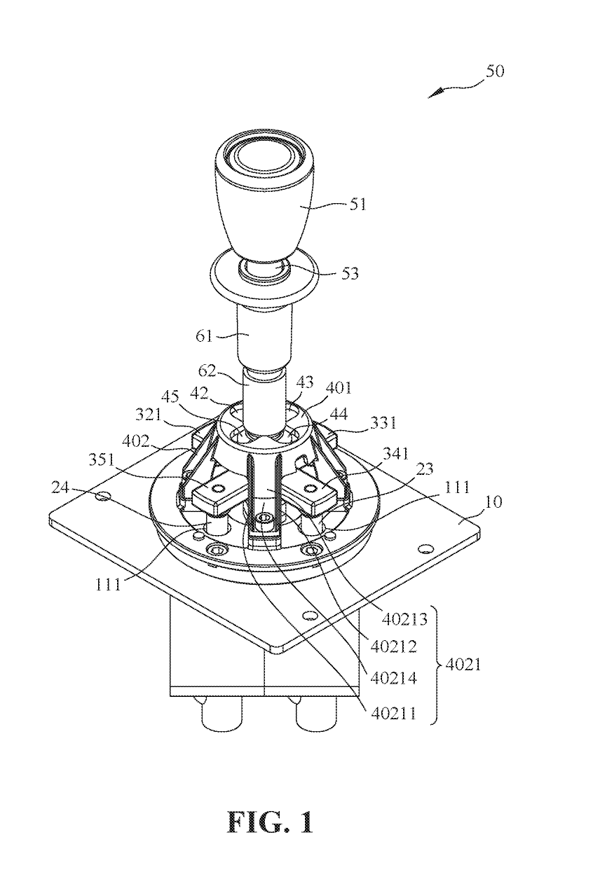

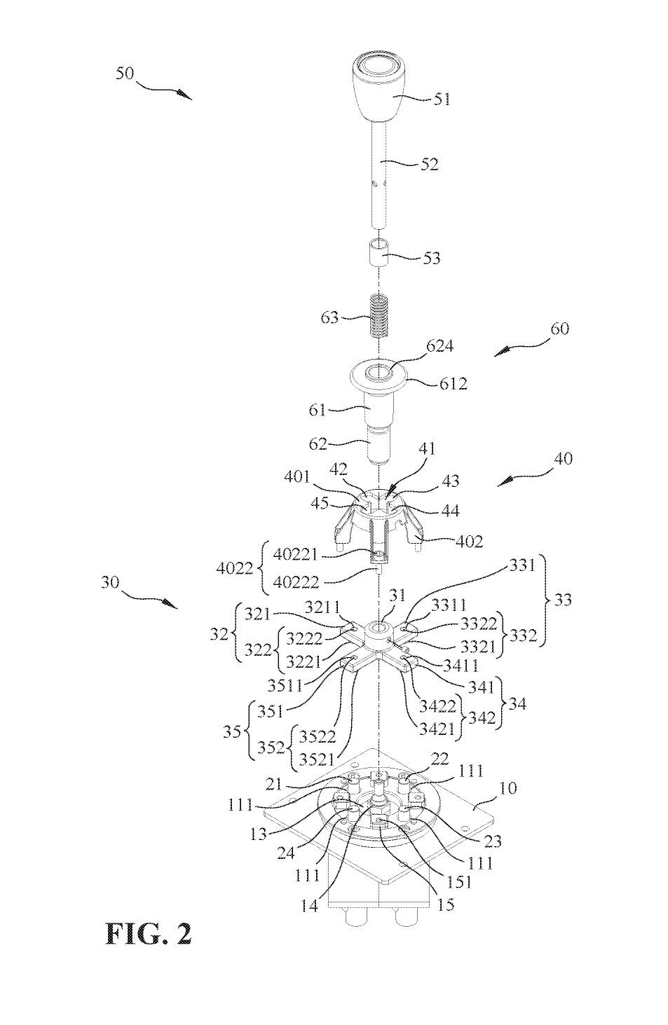

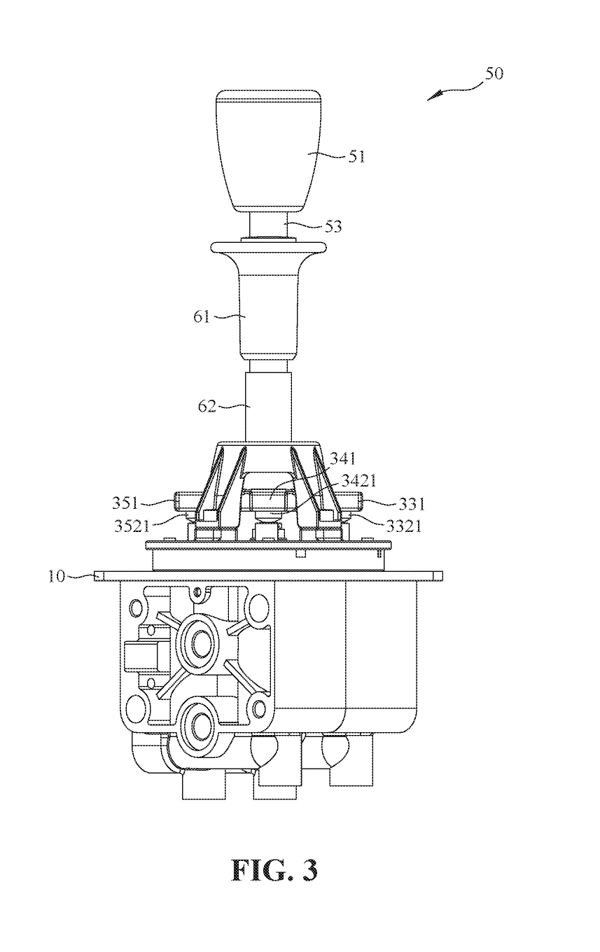

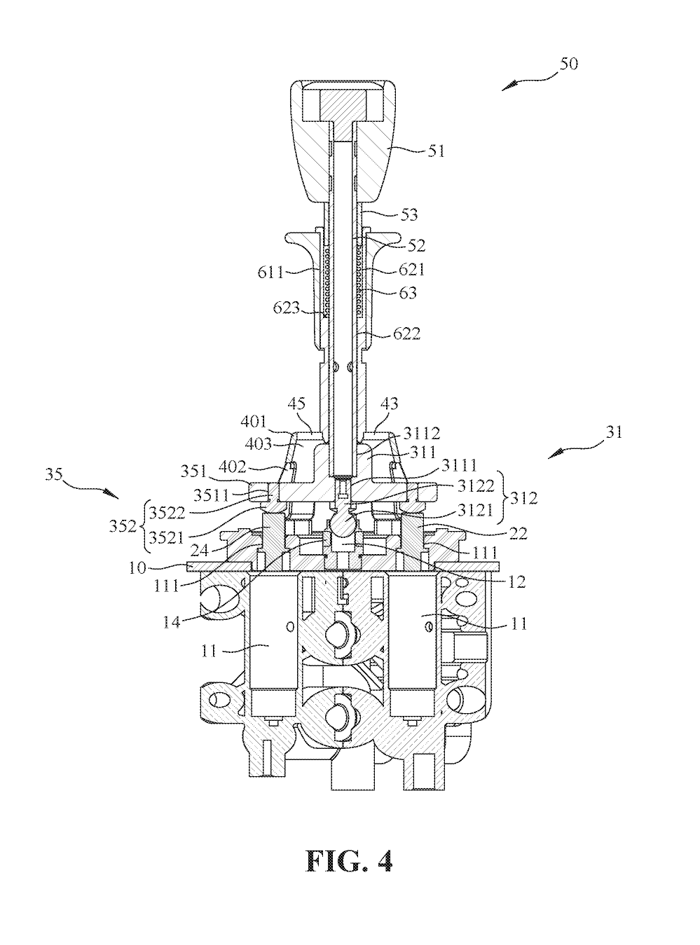

Referring to FIGS. 1-4, wherein FIG. 1 is a perspective view of a pressure operating device of the present invention; FIG. 2 is a perspective and exploded view of the pressure operating device of the present invention; FIG. 3 is a lateral side view of the pressure operating device of the present invention; and FIG. 4 is a cross-sectional view of the pressure operating device of the present invention. As illustrated, a pressure operating device of the present invention includes a base seat 10, a plurality of piston valves 21-24, a pressure disk 30, a guide member 40, an operating rod unit 50 and a position restricting member 60.

The base seat 10 is formed with a plurality of fluid channels 11.

The plurality of piston valves 21-24 are disposed respectively at the fluid channels 11 such that high compressed fluid coming in from a pneumatic power source (not shown) is capable of compelling and disposing the piston valves 21-24 at a closed position. As best illustrated in FIGS. 1, 3 and 4, under this condition, the high compressed fluid is prevented from entering into the pressure operating device of the present invention. In one embodiment of the present invention, the base seat 10 is formed with four fluid channels 11 while four piston valves 21-24 are disposed above and at the openings 111 of the fluid channels 11 respectively such that at the normal condition, the piston valves 21-24 are disposed in the closed position due to compression of the compressed fluid utilized herein. Note that the four piston valves 21-24 of the pressure operating device of the present invention correspond to four different operation modes of a hydraulic power machine, like a dump truck or a derrick crane of an engineering machine (not visible). For instance, movement to the leftwise and rightwise directions and/or upward and downward directions. When the piston valves 21-24 are disposed in the closed position, the hydraulic power machine is not activated.

The pressure disk 30 includes a swing seat 31 disposed movably above the base seat 10 and a plurality of swing arms 32-35 extending outwardly from the swing seat 31 and disposed respectively above the piston valves 21-24. To be more specific, an upper side of the base seat 10 is formed with a socket 12 (see FIG. 4). The swing seat 31 includes a cylindrical swing body 311 and a universal joint 312. The swing body 311 defines a large diameter portion 3112 for receiving an operating shaft 52 of the operating rod unit 50 and a small diameter portion 3111 below the large diameter portion 3112. The universal joint 312 has a head body 3121 for movably disposed in the socket 12 of the base seat 10 and a post body 3122 extending upward from the head body 3121 for coupling with the small diameter portion 3111 of the swing body 311 such that the swing seat 31 is swingable relative the base seat 10. In this embodiment, the upper side of the base seat 10 is formed with a circular recess 13, a seat body 14 is mounted on a bottom surface of the circular recess 13 and defining the socket 12 at its central portion thereof. The fluid channels 11 are located angularly around the seat body 14 in the circular recess 13. Four swing arms 32-35 extend outwardly and radially from a co-axis of the swing body 311 in a cross shape manner such that the swing arms 32-35 are disposed in a same plane. In another embodiment, the two pairs swing arms 32-35 extend outwardly and radially from the swing body 311 in a cross shape manner but the two pairs are not disposed in the same plane. Note that the number of swing arms and configuration of them relative to the swing body 311 can be varied according to the requirements and should not be limited only to the disclosed embodiments. To be more specific, each of the swing arms 32-35 includes an arm body 321, 331, 341, 351 and a press block 322, 332, 342, 352. The arm body 321, 331, 341, 351 extends outwardly and radially from a bottom portion of the swing body 311 and is formed with a through hole 3211, 3311, 3411, 3511. Each press block 322, 332, 342, 352 has a press head 3221, 3321, 3421, 3521 and a press pin 3222, 3322, 3422, 3522 being smaller than the press head 3221, 3321, 3421, 3521 in cross section and extends through the through hole 3211, 3311, 3411, 3511 in the arm body 321, 331, 341, 351 so as to dispose the press head 3221 above a corresponding one of the piston valves 21-24.

The guide member 40 is disposed above the pressure disk 30, has an axial hole 41 and a plurality of guide channels 42-45 surrounding and in spatial communication with the axial hole 41 in such a manner that the guide channels 42-45 extend from a co-axis of the axial hole 41 in a cross shape and corresponding to the swing arms 32-35 of the swing seat 31. In another embodiment, the guide channels 42-45 extend from the axial hole 41 in a cross shape but the two pairs are not disposed in the same plane. Note that the number of the guide channels 42-45 and configuration of them relative to the axial hole 41 can be varied according to the requirements and should not be limited only to the disclosed embodiment. To be more specific, the guide member 40 includes an annular guide seat 401 formed with the axial hole 41 and the guide channels 42-45, and a plurality of support legs 402 disposed between the guide seat 401 and the base seat 10 so as to define a receiving space 403 thereamong to accommodate the swing seat 31 in such a manner that the arm body 321, 331, 341, 351 of each of the swing arms 32-35 extends outwardly of the receiving space 403. Preferably, each of the support legs 402 extends outwardly and downwardly from the guide seat 401 toward the base seat 10 while the arm body 321, 331, 341, 351 of each of the swing arms 32-35 extends outwardly of the receiving space 403 through an adjacent pair of the support legs 402 so as to be disposed above the base seat 10. Preferably, the base seat 10 further has a plurality of fixing fixtures 15 on the upper side thereof, each is formed with an insert hole 151 and is located between an adjacent pair of the fluid channels 11. Each of the support legs 402 includes an extension portion 4021 and an insert pin 4022. Each extension portion 4021 has first and second extension plates 40211, 40212 extending downwardly and outwardly from the guide seat 401, a third extension plate 40213 extending downward from the guide seat 401 for interconnecting with the first and second extension plates 40211, 40212 and a fourth extension plate 40214 extending outward from a bottom end of the third extension plate 40213 away from the guide seat 401 for interconnecting with the first and second extension plates 40211, 40212 and formed with a through hole. Each insert pin 4022 has a pin head 40221 and a pin shaft 40222 with a cross section smaller than the pin head 40221 extending through the through hole in the fourth extension plate 40214 and inserted into the insert hole 151 of a respective one of the fixing fixtures 15, thereby disposing the pin head 40221 among the first, second, third and fourth extension plates 40211, 40212, 40213, 30214 and subsequently mounting the support legs 402 of the guide seat 401 securely on the base seat 10 but not hindering swinging of the swing seat 31 relative to the base seat 10.

The operating rod unit 50 extends through the axial hole 41 of the guide member 40 for coupling with the swing seat 31. To be more specific, the operating rod unit 50 includes a head 51, an operating shaft 52 coupled to the head 51 and extending through the axial hole 41 in the guide member 40 for coupling with the large diameter portion 3112 of the swing body 311, and a tubular sleeve 53 sleeved around the shaft 52 and disposed adjacent to the head 51.

The position restricting member 60 is coupled to the operating rod unit 50 so as to restrict the operating rod unit 50 between a locked position and an unlocked position. To be more specific, the position restricting member 60 includes an outer sleeve 61 sleeved around the operating shaft 52 and defining an axial hole 611, an inner sleeve 62 disposed within the axial hole 611 and sleeved around the operating shaft 52, exposing at least partially from a bottom end of the outer sleeve 61 and having an inner peripheral surface defining a large diameter section 621 to permit extension of the tubular sleeve 53, a small diameter section 622 and a shoulder portion 623 between the large diameter section 621 and the small diameter section 622, and a spring 63 disposed within the inner sleeve 62 around the operating shaft 52 and having two opposite ends respectively biasing the shoulder portion 623 and the tubular sleeve 53. Preferably, the outer sleeve 61 further has an annular first flange 612 extending outwardly and radially from a periphery confining an upper part of the outer sleeve 61 while the inner sleeve 62 further has an annular second flange 624 extending outwardly and radially from a periphery confining an upper part of the inner sleeve 62 such that the second flange 624 is located above and detachably contact with the first flange 612.

Referring to FIGS. 1, 3 and 4, when the position restricting member 60 is disposed a locked position, the inner sleeve 62 extends fittingly into the axial hole 41 in the guide seat 41 and subsequently preventing the operating shaft 52 from entering into any one of the guide channels 42-45 of the guide member 40 and hence preventing swinging of the swing seat 31 relative to the guide member 40, thereby preventing accidentally activation of the operating shaft 52 of the operating rod unit 50 and providing safety measures to the environment of the pressure operating device of the present invention. Note that the axial hole 41 in the guide seat 41 is large enough to permit fittingly extension of the inner sleeve 62 of the position restricting member 60 while each of the guide channels 42-45 has a cross section small enough to prevent entering of the inner sleeve 62 into the same except the operating shaft 52.

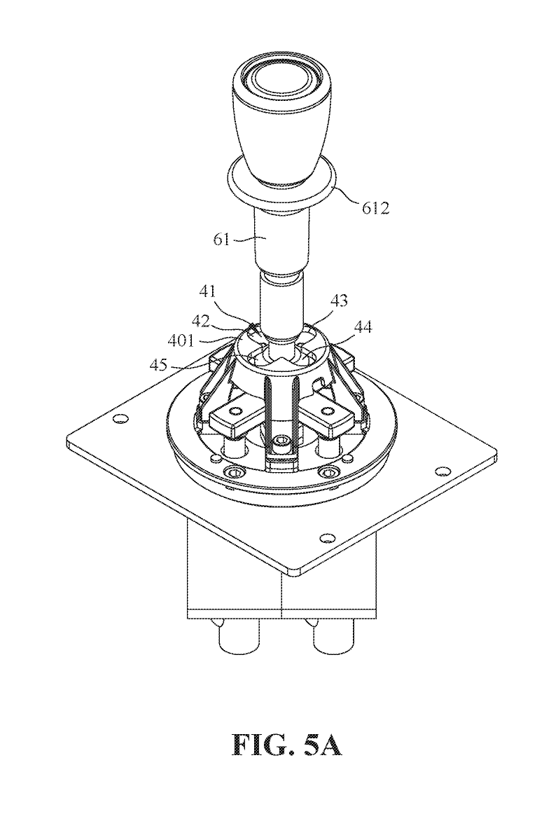

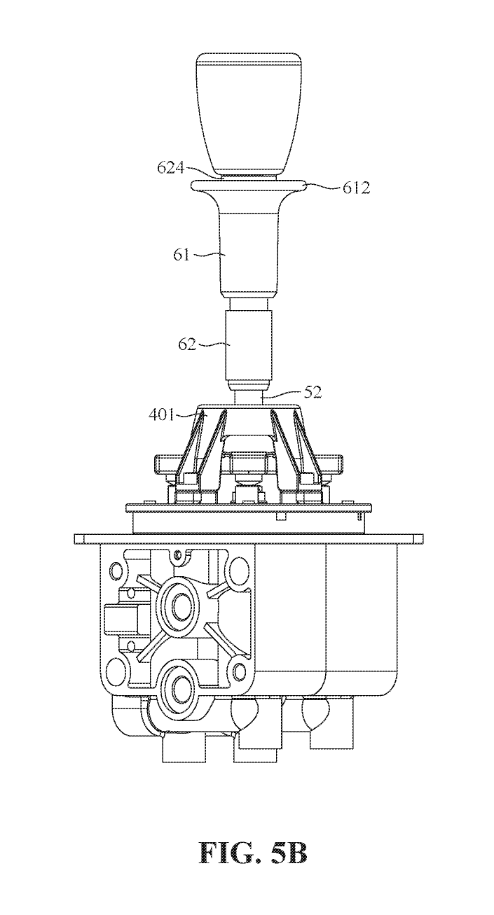

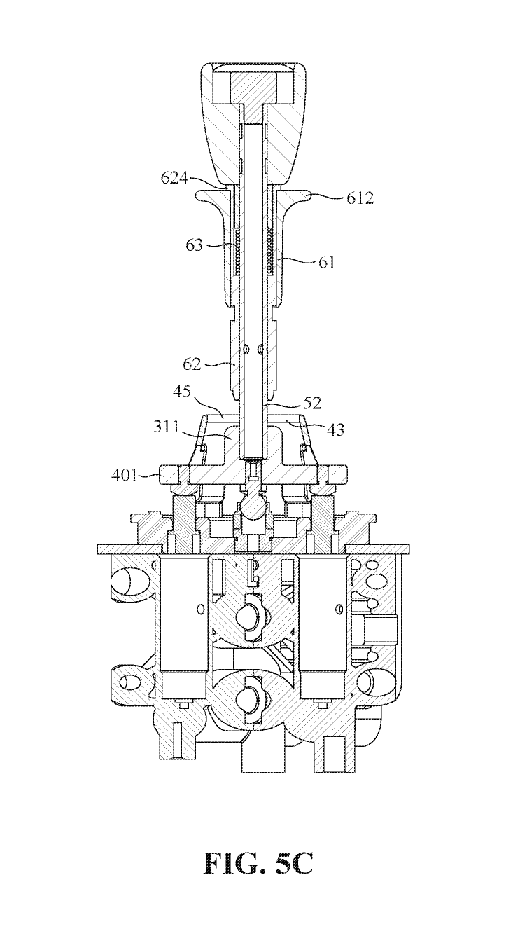

FIG. 5A illustrates a perspective view of the pressure operating device of the present invention at an unlocked position; FIG. 5B illustrates a perspective and lateral side view of the pressure operating device of the present invention at the unlocked position; and FIG. 5C illustrates a perspective and cross-sectional view of the pressure operating device of the present invention at the unlocked position. Under this condition, in case an operator operates in such a manner that simultaneous upward movement of the outer and inner sleeves 61, 62 along the operating shaft 52 results in compression of the spring 63 and disengaging the inner sleeve 62 from the axial hole 41 in the guide seat 41 to allow the operating shaft 52 entering freely into any one of the guide channels 42-45 of the guide seat 41 and subsequently permitting swinging of the swing body 311 relative to the guide seat 41.

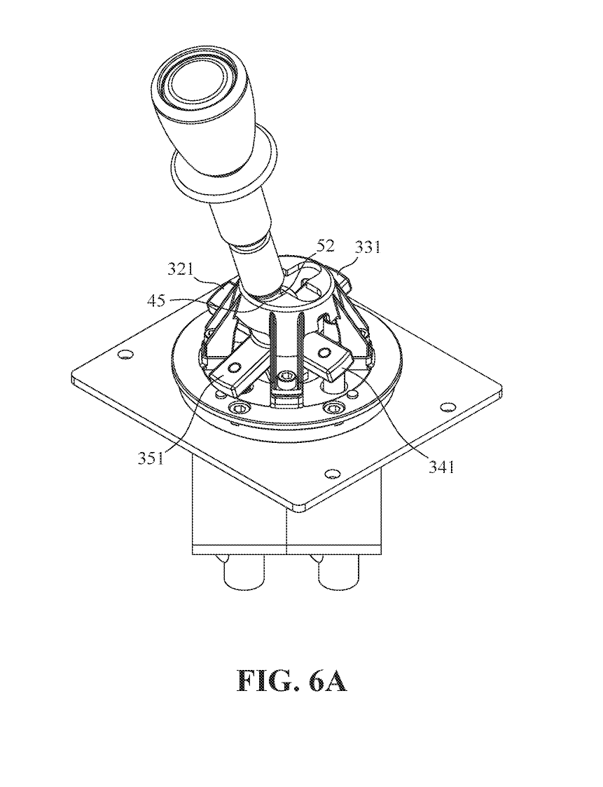

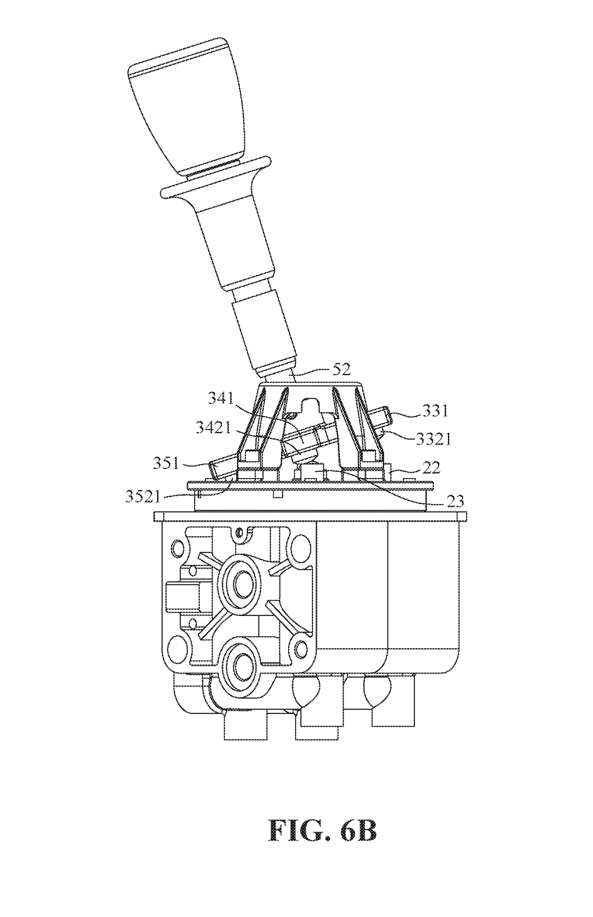

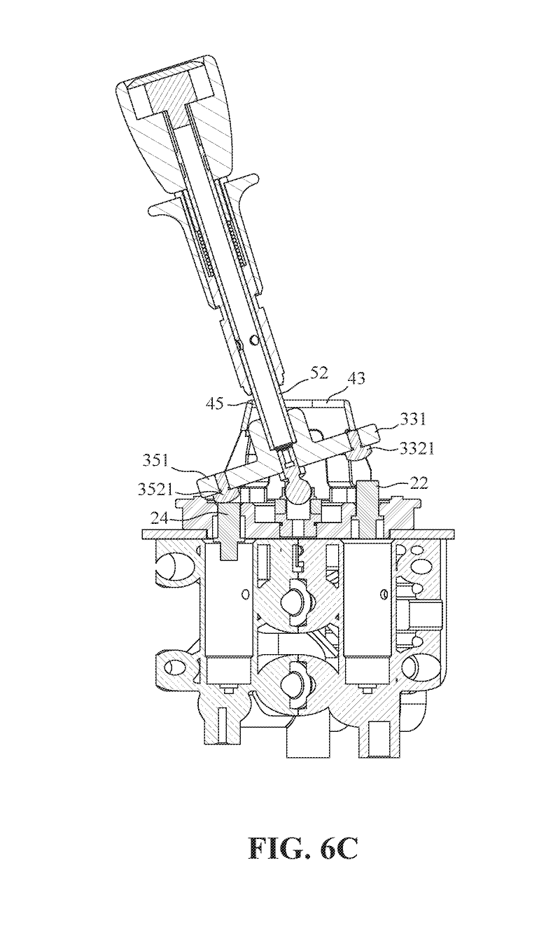

Referring to FIGS. 6A, 6B and 6C, wherein FIG. 6A shows a perspective movement of an operating shaft 52 into one of plurality of guide channels 42-45 in a guide seat 41 so as to swing the swing seat 31 relative to the base seat 10 to extend one swing arm 32-35 of the swing seat 31 compressing a piston valve 21-24 below in the pressure operation device of the present invention; FIG. 6B shows a lateral side movement of the operating shaft 52 into one of plurality of guide channels 42-45 in the guide seat so as to swing the swing seat relative to the base seat to extend the swing arm 32-35 of the swing seat 31 compressing the piston valve 21-24 below in the pressure operation device of the present invention; and FIG. 6C shows a cross-sectional movement of the operating shaft 52 into one of plurality of guide channels 42-45 in the guide seat 41 so as to swing the swing seat 31 relative to the base seat 10 to extend the swing arm 32-35 of the swing seat 31 compressing the piston valve 21-24 below in the pressure operation device of the present invention. Note that when the operator operates the position restricting member 60 in such a manner that movement of the operating shaft 52 of the operating rod unit 50 into the guide channel 45 results in swinging of the swing seat 31 to respective one of the guide channels 42-45, thereby swinging a respective swing arm 35 above and pressing the press head 3521 of the press block 352 against a corresponding piston valve 24 downward and opening the corresponding piston valve 24 to permit entry of the high pressure fluid into the pressure operating device while the press heads 3221, 3321, 3421 of the press blocks 322, 332, 342 in the remaining the swing arms 32-34 are spaced apart from and maintaining remaining the piston valves 21-23 in the closed position. Under this condition, the hydraulic power machine equipped with the pressure operating device of the present invention is activated only in a single operation mode. In other words, the guide member 40 can precisely control the operating rod unit 50 to move relative to the pressure disk 30 only in a single operation at one time, thereby preventing the hydraulic power machine from operating in multiple operation modes due to accidentally activation of the operating rod unit 50.

It is to note that the operator needs not exert any force to move the operating rod unit 50 sidewise of the guide member 40, the opening 111 of the corresponding piston valve 24 is blocked due to entering of high-compressed fluid into the pressure operating device of the present invention. Note that after assembly of the pressure operating device of the present invention, the restoration of the spring 63 along the operating shaft 52 results in biasing of the tubular sleeve 53 and pushing the inner sleeve 62 along the operating shaft 52 to extend into the axial hole 41 in the guide seat 401, thereby disposing the operating rod unit 50 into the locked position.

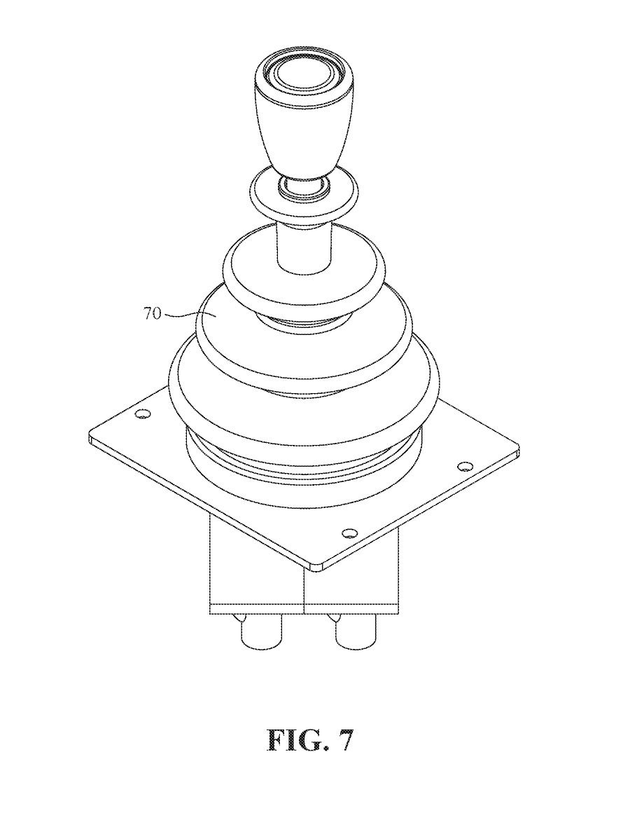

FIG. 7 shows a perspective view of a modified pressure operating device of the present invention, wherein the modified pressure operating device is similar to the previous embodiment, except in a protection sheath 70 disposed on the base seat 10 for covering and concealing the plurality of fluid channels 11 in the base seat 10, the piston valves 21-24, the pressure disk 30, the guide member 40 and exposing partially the inner and outer sleeves 61, 62 of the position restricting member 60, and the head 51 and the operating shaft 52 of the operating rod unit 50. Note that the protection sheath 70 is fabricated from elastic material, like rubber and has limited elasticity and does not hinder movement of the position restricting member 60 and the operating rod unit 50 relative to the guide member 40 and the base seat 10.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A pressure operating device comprising:
a base seat formed with a plurality of fluid channels;
a plurality of piston valves disposed respectively at said fluid channels such that high pressure fluid coming in from a pneumatic power source is capable of compelling said piston valves to a closed position;
a pressure disk including a swing seat disposed above said base seat and a plurality of swing arms extending outwardly from said swing seat and disposed respectively above said piston valves;
a guide member disposed above said pressure disk, having an axial hole and a plurality of guide channels surrounding and in spatial communication with said axial hole and corresponding to said swing arms; and
an operating rod unit extending through said axial hole of said guide member for coupling with said swing seat in such a manner that movement of said operating rod unit into one of said guide channels results in swinging of said swing seat to respective one of said guide channels, thereby swinging a respective one of said swing arms above and pressing a corresponding one of said piston valves downward and opening said corresponding one of said piston valves to permit entry of said high pressure fluid into the pressure operating device while remaining said swing arms are spaced apart from and maintaining remaining said piston valves in said closed position.

2. The pressure operating device according to claim 1, further comprising a position restricting member coupled to said operating rod unit so as to restrict said operating rod unit between a locked position, where said position restricting member is inserted into said axial hole in said guide member to prevent movement of said operating rod unit into any one of said guide channels of said guide member and subsequently preventing swinging of said swing seat relative to said guide member and an unlocked position, where said position restricting member disengages from said axial hole in said guide member to permit movement of said operating rod unit into any one of said guide channels of said guide member and subsequently permitting swinging of said swing seat relative to said guide member.

3. The pressure operating device according to claim 2, wherein said operating rod unit includes a head, an operating shaft coupled to said head and extending through said axial hole in said guide member for coupling with said swing seat, and a tubular sleeve sleeved around said operating shaft and disposed adjacent to said head, wherein said position restricting member includes an outer sleeve sleeved around said operating shaft and defining an axial hole, an inner sleeve disposed within said axial hole and sleeved around said operating shaft and exposing at least partially from a bottom end of said outer sleeve and having an inner peripheral surface defining a large diameter section to permit extension of said tubular sleeve, a small diameter section and a shoulder portion between said large diameter section and said small diameter section, and a spring disposed within said inner sleeve around said operating shaft and having two opposite ends respectively biasing said shoulder portion and said tubular sleeve and biasing said inner sleeve into said axial hole in said guide member subsequently preventing said operating shaft from entering into any one of said guide channels of said guide member and preventing swinging of said swing seat relative to said guide member, thereby disposing said operating rod unit at said locked position, and simultaneous upward movement of said outer and inner sleeves along said operating shaft results in compression of said biasing spring and disengaging said inner sleeve from said axial hole in said guide member to allow said operating shaft entering freely into any one of said guide channels of said guide member and subsequently permitting swinging of said swing seat relative to said guide member, thereby disposing said operating rod unit at said unlocked position.

4. The pressure operating device according to claim 3, wherein said outer sleeve further has an annular first flange extending outwardly and radially from a periphery confining an upper part of said outer sleeve and said inner sleeve further has an annular second flange extending outwardly and radially from a periphery confining an upper part of said inner sleeve such that said second flange is located above and detachably contact with said first flange.

5. The pressure operating device according to claim 3, further comprising a protection sheath disposed on said base seat and covering and concealing said plurality of fluid channels, said piston valves, said pressure disk, said guide member and exposing partially said inner and outer sleeves of said position restricting member, and said head and said operating shaft of said operating rod unit.

6. The pressure operating device according to claim 1, wherein said guide member includes a guide seat formed with said axial hole and said guide channels and a plurality of support legs disposed between said guide seat and said base seat so as to define a receiving space thereamong to accommodate said swing seat in such a manner that each of said swing arms extends from said swing seat outwardly of said receiving space.

7. The pressure operating device according to claim 6, wherein each of said support legs extends outward and downwardly from said guide seat toward said base seat while each of said swing arms extends outwardly of said receiving space through an adjacent pair of said support legs, thereby disposing said support legs on an upper side of said base seat.

8. The pressure operating device according to claim 7, wherein said base seat further has a plurality of fixing fixtures on said upper side thereof, each is formed with an insert hole and located between an adjacent pair of said fluid channels, each of said support legs includes an extension portion and a insert pin, each extension portion having first and second extension plates extending downwardly and outwardly from said guide seat, a third extension plate extending downward from said guide seat for interconnecting with said first and second extension plates and a fourth extension plate extending outward from a bottom end of said third extension plate away from said guide seat for interconnecting with said first and second extension plates and formed with a through hole, each insert pin having a pin head and a pin shaft with a cross section smaller than said pin head extending through said through hole in said fourth extension plate and inserted into said insert hole of a respective one of said fixing fixtures, thereby disposing said pin head among said first, second, third and fourth extension plates and subsequently mounting said support legs of said guide seat securely on said base seat but not hindering swinging of said swing seat relative to said base seat.

9. The pressure operating device according to claim 1, wherein an upper side of said base seat is formed with a socket, said swing seat includes a swing body defining a large diameter portion for receiving an operating shaft of said operating rod unit and a small diameter portion below said large diameter portion and a universal joint having a head body for movably disposed in said socket of said base seat and a post body extending from said head body and coupling with said small diameter portion of said swing body.

10. The pressure operating device according to claim 9, wherein each of said swing arms includes an arm body extending outwardly and radially from a bottom portion of said swing body and formed with a through hole and a press block having a press head and a press pin being smaller than said press head in cross section and extending through said through hole in said arm body so as to dispose said press head above a corresponding one of said piston valves.
